(19) United States
(12) Patent Application Publication
(10) Pub. No.: US 2026/0010217 A1
(43) Pub. Date: Jan. 8, 2026

(54) POWER CONSUMPTION MANAGEMENT METHOD AND FRAME GENERATION DEVICE

(71) Applicant: MEDIATEK INC., Hsinchu City (TW)

(72) Inventors: Chih-Cheng Le, Hsinchu City (TW); Chia-Chi Lee, Hsinchu City (TW); Yu-Chieh Lin, Hsinchu City (TW); Hsien-Hsi Hsieh, Hsinchu City (TW); Cheng-Han Tsai, Hsinchu City (TW); Chiu-Jen Lin, Hsinchu City (TW); Cheng-Che Chen, Hsinchu City (TW)

(73) Assignee: MEDIATEK INC., Hsinchu City (TW)

(21) Appl. No.: 19/260,657

(22) Filed: Jul. 7, 2025

Related U.S. Application Data
(60) Provisional application No. 63/668,374, filed on Jul. 8, 2024.

(51) Int. Cl. G06F 1/3206

(52) U.S. Cl. CPC G06F 1/3206

(57) ABSTRACT

A power consumption management method, for managing power consumptions of units for performing a frame generation procedure to generate frames required by an application, comprising: (a) deciding a first operation time of at least one non-inference unit for performing non-inference stages of the frame generation procedure according to a target performance time determined by the application and historical data relevant to the non-inference stages; (b) computing a second operation time of an inference unit for performing an inference stage of the frame generation procedure, according to the target performance time and the first operation time; and (c) setting configurations of the inference unit according to the second operation time; wherein the at least one non-inference unit has a first power consumption rate higher than a second power consumption rate of the inference unit.

### CROSS REFERENCE TO RELATED APPLICATIONS

This application claims the benefit of U.S. Provisional Application No. 63/668,374, filed on Jul. 8, 2024. The content of the application is incorporated herein by reference.

### BACKGROUND

The present application relates to a power consumption management method and a frame generation device, and particularly relates to a power consumption management method and a frame generation device which can minimize power consumption while meeting the target performance time.

In recent years, mobile electronic devices have become increasingly popular, and therefore software vendors have developed a variety of third-party applications that can be used by mobile electronic devices. Users usually install various third-party applications with different functions on their mobile electronic devices. However, since the developers of these third-party applications are usually different from the developers of the mobile electronic device, the power consumption of the mobile electronic device is often not optimized when the mobile electronic device executes these third-party applications. For example, the graphics-related devices in each mobile electronic device generally have different capabilities. However, third-party applications may instruct these devices to operate with inappropriate parameters, thereby making the power consumption of the mobile electronic device non-optimal.

Accordingly, a new mechanism is needed to improve these problems.

### SUMMARY

One objective of the present invention is to provide a power consumption management method, which can optimize power consumption while generating frames required by a multimedia application.

One objective of the present invention is to provide a frame generation device, which can optimize power consumption while generating frames required by a multimedia application.

One embodiment of the present application discloses a power consumption management method, for managing power consumptions of units for performing a frame generation procedure to generate frames required by an application, comprising: (a) deciding a first operation time of at least one non-inference unit for performing non-inference stages of the frame generation procedure according to a target performance time determined by the application and historical data relevant to the non-inference stages; (b) computing a second operation time of an inference unit for performing an inference stage of the frame generation procedure, according to the target performance time and the first operation time; and (c) setting configurations of the inference unit according to the second operation time; wherein the at least one non-inference unit has a first power consumption rate higher than a second power consumption rate of the inference unit.

Another embodiment of the present application discloses a power consumption management method, for managing power consumptions of units for performing a frame generation procedure to generate frames required by an application, comprising: acquiring first power consumptions of a plurality of combinations respectively corresponding to different ones of first candidate operation times of a non-inference unit and different ones of second candidate operation times of an inference unit, wherein the first candidate operation times and the second candidate operation times are recorded in a first table; and selecting one of the first candidate operation times as a first operation time of the non-inference unit and one of the second candidate operation times as a second operation time of the inference unit, according to the first power consumptions and the target performance time, under a premise that the sum of the first operation time and the second operation time is less than or equal to the target performance time.

Still another embodiment of the present application discloses a frame generation device, for performing a frame generation procedure to generate frames required by a multimedia application, comprising: a non-inference unit; an inference unit; a performance arbitrator, configured to perform following steps: (a) deciding a first operation time of at least one non-inference unit for performing non-inference stages of the frame generation procedure according to a target performance time determined by the application and historical data relevant to the non-inference stages; (b) computing a second operation time of an inference unit for performing an inference stage of the frame generation procedure, according to the target performance time and the first operation time; and (c) setting configurations of the inference unit according to the second operation time; wherein the at least one non-inference unit has a first power consumption rate higher than a second power consumption rate of the inference unit.

In view of above-mentioned embodiments, the power consumption of the frame generation device may be optimized even if the frame generation device is executing a 3rd-party application.

These and other objectives of the present application will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating operations of a power consumption management method according to one embodiment of the present application.

FIG. 2 is a schematic diagram illustrating operations of the power consumption management method according to one embodiment of the present application.

FIG. 3 is a flow chart illustrating a power consumption management method according to another embodiment of the present application.

FIG. 4 is a flow chart illustrating summarized steps of a power consumption management method, according to one embodiment of the present application.

FIG. 5 is a flow chart illustrating summarized steps of a power consumption management method, according to one embodiment of the present application.

FIG. 6 is a block diagram illustrating a frame generation device according to one embodiment of the present application.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices. In following embodiments, the term “unit” may mean a device, or a circuit.

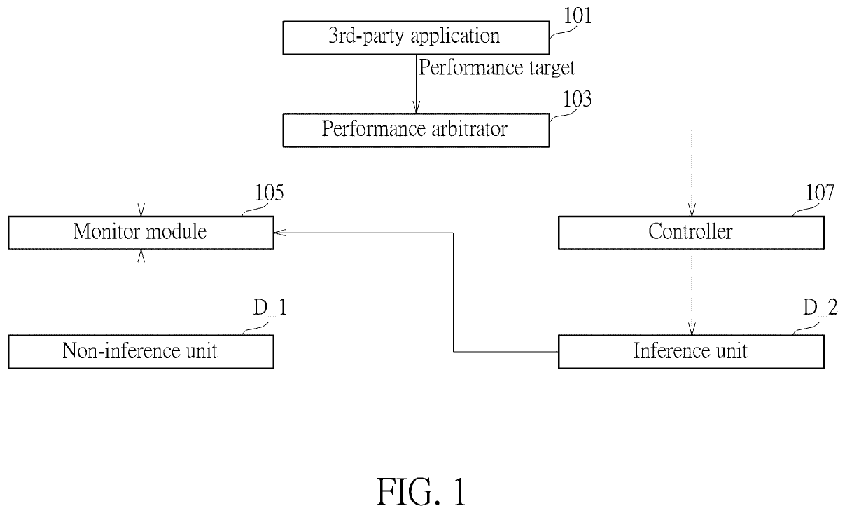

FIG. 1 is a block diagram illustrating operations of a power consumption management method according to one embodiment of the present application. As shown in FIG. 1, the 3rd-party application 101, which is a multimedia application such as a game application, provides target performance time PT and requirement of drawing (frame generation). In one embodiment, the target performance time PT is determined based on a target frame rate of frames which are generated responding to the requirement of drawing. The performance arbitrator 103 decides a first operation time of a non-inference unit D_1 according to the target performance time PT. The monitor module 105, which may be a circuit or a device, is configured to monitor the first operation time and the second operation time. Please note, the number of the non-inference unit D_1 can be more than one but only one non-inference unit is used as an example for explaining.

The non-inference unit D_1 performs non-inference stages of a frame generation procedure. Also, the performance arbitrator 103 computes a second operation time of an inference unit D_2 according to the target performance time PT and the first operation time. The inference unit D_2 performs an inference stage of the frame generation procedure. The above-mentioned first operation time is determined by the target performance time PT and historical data relevant to the non-inference stages.

The historical data can be, for example, a default table or default values. In one embodiment, the first operation time is decided according to the first operation time used in at least one previous frame. For example, the current first operation time may be the first operation time which is used in a previous frame or may be an average of first operation times of three previous frames.

After that, the performance arbitrator 103 provides commands to the controller 107 to set configurations of the inference unit D_2 according to the second operation time. The controllers 107 mentioned here may mean a circuit or a device which is responsible for controlling the inference unit D_2.

In one embodiment, configurations of the inference unit D_2 includes a number of operating cores (e.g., CPU core or processing circuits) of the inference unit D_2 and operating frequencies corresponding to the operating cores. Also, the configurations are set under a premise that the sum of the first operation time and the second operation time is less than or equal to the target performance time PT.

In one embodiment, the second operation time has a minimum threshold. In such case, if the second operation time is set to a minimum second operation time, the first operation time is equal to the target performance time minus the minimum second operation time. The minimum threshold can be determined based on various rules. For example, the minimum threshold can be determined by the necessary time of the inference stage.

The non-inference unit D_1 has a first power consumption rate higher than a second power consumption rate of the inference unit D_2. In one embodiment, the non-inference unit D_1 is a video decoder, a CPU (Central Processing Unit) or a GPU (Graphical Processing Unit), and the inference unit D_2 is an AI processor (e.g., a processing circuit using an AI algorithm).

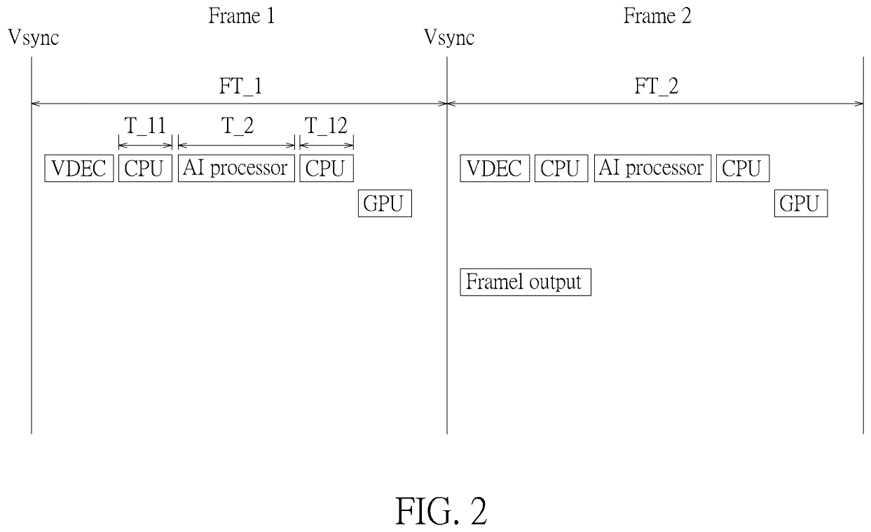

FIG.2 is a schematic diagram illustrating operations of the power consumption management method according to one embodiment of the present application. Please refer to FIG. 1 and FIG. 2 together to understand the concept of the present application for more clarity. In the embodiment of FIG.2, the above-mentioned non-inference unit D_1 is a CPU and the above-mentioned inference unit D_2 is an AI processor. Also, in FIG. 2, the frame period FT_1 means a frame period of Frame 1. The generation of Frame 1 must be completed in the frame period FT_1 and then Frame 1 is output for displaying, or the generating of Frame 1 will fail. A portion or all of the frame period may mean the above-mentioned target performance time PT.

In FIG.2, the generation of Frame 1 is performed by a frame pipeline comprising a video decoder (VDEC), the CPU, the AI processor and a GPU. In other words, the CPU performs non-inference stages of generating the Frame 1, and the AI processor performs a inference stage of generating the Frame 1. As above-mentioned, the first operation time T_11, T_12 of the CPU are firstly decided, and then the second operation time of the AI processor is computed according to the target performance time PT and the first operation time T_11, T_12. As above-mentioned, the non-inference unit D_1 may have a first power consumption rate higher than a second power consumption rate of the inference unit D_2. Accordingly, in the embodiment of FIG. 2, the CPU has a power consumption rate higher than a power consumption rate of the AI processor.

For example, the CPU and AI processor can operate at different operation levels. The higher the operation level, the stronger the function but the greater the power consumption rate. For example, a CPU running at 3 GHz in the lowest operation level consumes 20 mA per second, while running at 5 GHz in the second highest operation level consumes 50 mA per second. The aforementioned “the device has a higher power consumption rate” means that for every operation level increase of this device, the increase in its current consumption per second is greater than the increase in the current consumption per second of another device when it's operation level is increased by one level. Taking the above examples for explaining, the current consumed per second increases by 30 mA for each operation level increase in the CPU, and the current consumed per second increases by 10 mA for each operation level increase in the AI processor.

Accordingly, in one embodiment, an operation level of the non-inference unit D_1 is reduced as much as possible to decide the first operating time, to reduce the total power consumption. The higher the operation level is, the shorter the first operation times T_11, T_12 are. On the opposite, the lower the operation level is, the longer the first operation times T_11, T_12 are. However, if the first operation times T_11, T_12 are too long, the second operation time T_2 will become too short thus even if the AI processor is running at the highest operation level, it will not be able to completes its work in time. In other words, such case may be regarded as an example that the second operation time T_2 is smaller than a minimum second operation time. Accordingly, the decision of the first operating time may be based on the target performance time PT.

Accordingly, the first operation time is decided under a premise that performance of the frame pipeline meets the target performance time PT. For example, even if the operation level of the non-inference unit D_1 is reduced as much as possible, which means the first operation time is extended as long as possible, it is still limited to that the performance of the frame pipeline meets the target performance time PT. For example, the sum of the first operation time and the second operation time, is less than or equal to the target performance time PT.

As above-mentioned, the non-inference unit may be a video decoder, a CPU or a GPU, and the CPU is used as an example for explaining the operations of the non-inference unit D_1 in above-mentioned embodiments. Accordingly, the video decoder and the GPU may also follow the above-mentioned rules.

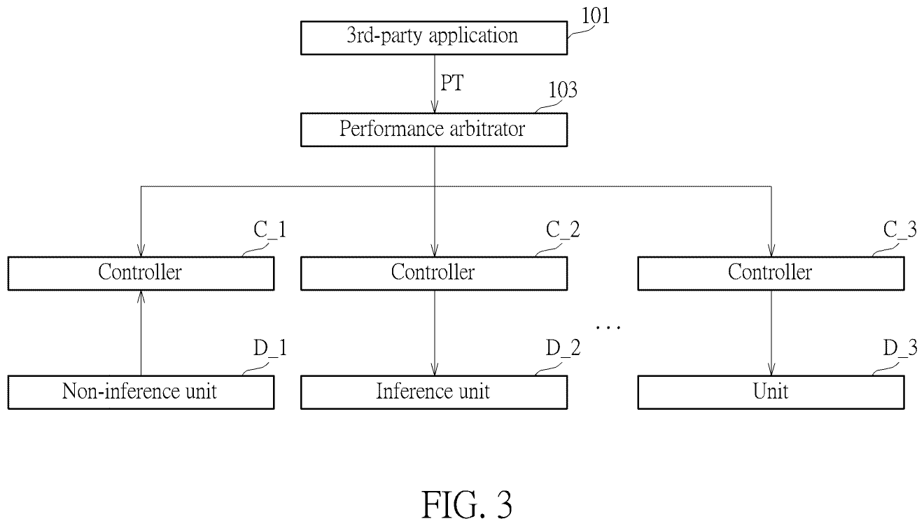

Besides the above-mentioned embodiments, the operation time of the units can be decided by other methods. FIG. 3 is a flow chart illustrating a power consumption management method according to another embodiment of the present application. In the embodiment of FIG. 3, first power consumptions of a plurality of combinations respectively corresponding to different ones of first candidate operation times of a non-inference unit and different ones of second candidate operation times of an inference unit are acquired. The first candidate operation times and the second candidate operation times are recorded in a first table

Then, one of the first candidate operation times is selected as a first operation time of the non-inference unit D_1 and one of the second candidate operation times as a second operation time of the inference unit D_2, according to the first power consumptions and the target performance time PT.

For example, in one embodiment, the frame pipeline only has a non-inference unit D_1 which is a video decoder and an inference unit D_2 which is an AI processor, and the frame period is 15 ms to complete. Also, the video decoder needs 100 mA of current if the first operation time is 10 ms, or 200 mA of current if the first operation time is 5 ms. Further, the AI processor needs 80 mA of current if the second operation time is 10 ms, or 60 mA of current if the second operation time is 5 ms.

In one embodiment, the first combination means the first operation time is 10 ms and the second operation time is 5 ms, and the second combination means the first operation time is 5 ms and the second operation time is 10 ms. Accordingly, it can be obtained that the total operation time of the first combination is 10 ms+5 ms, and the corresponding power consumption is 100 mA+60 mA=160 mA. Further, the total operation time of the second combination is 5 ms+10 ms, and the corresponding power consumption is 200 mA+80 mA=280 mA. Therefore, choosing the first combination can achieve the lowest power consumption while meeting the target performance time PT. After selecting the first combination, the performance arbitrator 103 may informs the controller C_1, C_2 which respectively controls the non-inference unit D_1 and the inference unit D_2 to change the configurations of the non-inference unit D_1 and the inference unit D_2. In one embodiment, the configurations of another unit D_3 which is also a unit of the above-mentioned frame pipeline. The controllers C_1, C_2 mentioned here may mean a circuit or a device which is responsible for controlling the non-inference unit D_1 or the inference unit D_2. Alternatively, the controllers C_1, C_2 may mean software which is executed to control the non-inference unit D_1 or the inference unit D_2.

Please note, in one embodiment, the first candidate operation time and the second candidate operation time in each combination also follows the rule of the target performance time PT. Specifically, for each of the combinations, the first candidate operation time and the second candidate operation time are decided under a premise that performance of the frame pipeline meets the target performance time PT.

In another embodiment, second power consumptions corresponding to operation levels of the units except the non-inference device and the inference device are acquired. The second power consumptions are recorded in a second table. For example, the second power consumptions corresponding to operation levels of the unit D_3 are acquired. Afterwards, select one of the operation levels according to the second power consumptions under a premise that the sum of the first operation time, the second operation time and operation times of the units except the non-inference device and the inference device is less than or equal to the target performance time. For example, an operation level of the unit D_3 is selected such that the unit D_3 has a lowest power consumption under a premise that the sum of the first operation time, the second operation time and the operation times of the unit D_3 is less than or equal to the target performance time.

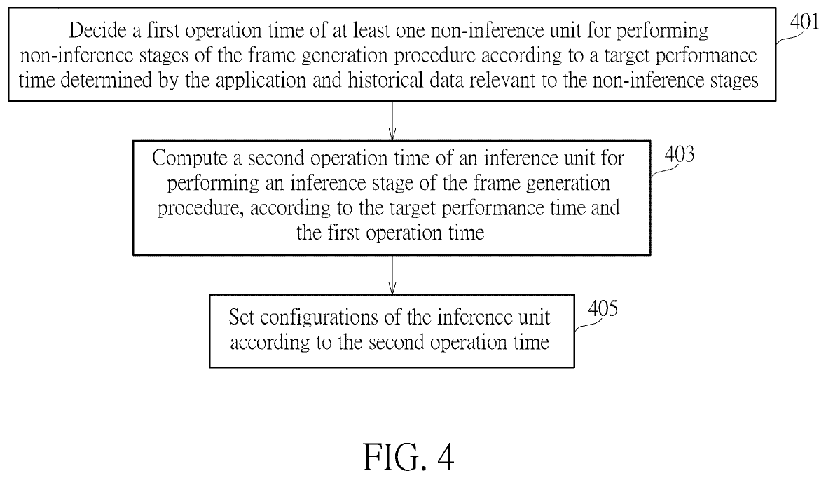

In view of above-mentioned descriptions, a power consumption management method can be acquired. FIG. 4 is a flow chart illustrating summarized steps of a power consumption management method, according to one embodiment of the present application. The power consumption management method is for managing power consumptions of units for performing a frame generation procedure for generating frames required a multimedia application, and comprises following steps:

### Step 401

Decide a first operation time of at least one non-inference unit (e.g., D_1) for performing non-inference stages of the frame generation procedure according to a target performance time determined by the application and historical data relevant to the non-inference stages;

### Step 403

Compute a second operation time of an inference unit for performing an inference stage of the frame generation procedure, according to the target performance time and the first operation time

### Step 405

Set configurations of the inference unit according to the second operation time.

The non-inference unit has a first power consumption rate higher than a second power consumption rate of the inference unit

In one embodiment, the power consumption management method further comprises: the step 401 decides the first operation time under a premise that the sum of the first operation time and the second operation time, based on the historical data, is less than or equal to the target performance time.

In another embodiment, the configurations of the inference unit includes a number of operating cores of the inference unit and operating frequencies corresponding to the operating cores, and the configurations are set under a premise that the sum of the first operation time and the second operation time is less than or equal to the target performance time

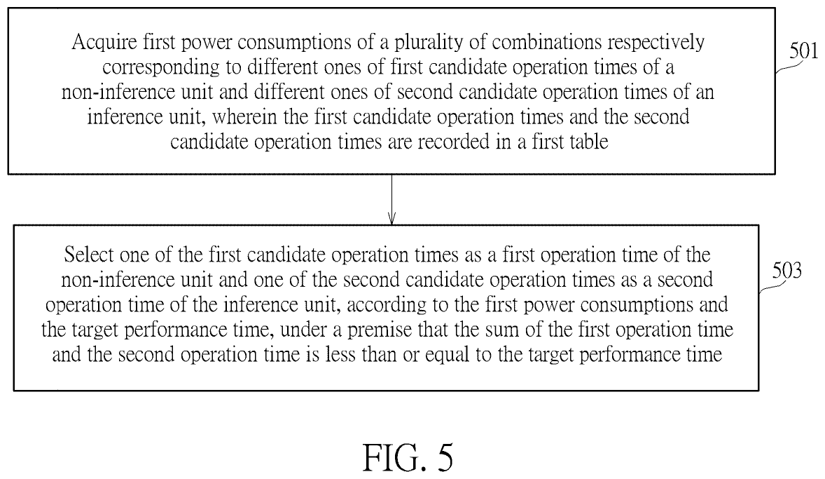

FIG. 5 is a flow chart illustrating summarized steps of a power consumption management method, according to one embodiment of the present application.

The power consumption management method in FIG. 5 comprises:

### Step 501

Acquire first power consumptions of a plurality of combinations respectively corresponding to different ones of first candidate operation times of a non-inference unit (e.g., D_1) and different ones of second candidate operation times of an inference unit (e.g., D_2), wherein the first candidate operation times and the second candidate operation times are recorded in a first table.

### Step 503

Select one of the first candidate operation times as a first operation time of the non-inference unit and one of the second candidate operation times as a second operation time of the inference unit, according to the first power consumptions and the target performance time, under a premise that the sum of the first operation time and the second operation time is less than or equal to the target performance time.

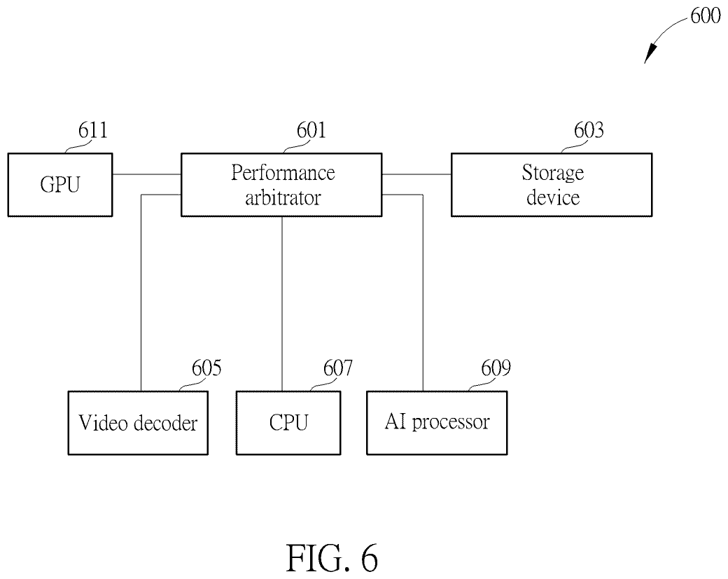

FIG. 6 is a block diagram illustrating a frame generation device according to one embodiment of the present application. As shown in FIG. 6, the frame generation device 600 comprises a performance arbitrator 601, a storage device 603, a video decoder 605, a CPU 607, an AI processor 609 and a GPU 611. The performance arbitrator 601, which can be a circuit or a device, may execute at least one program stored in the storage device 603 to perform the above-mentioned power consumption management method. The storage circuit 603, the video decoder 605, the CPU 607, the AI processor 609 and the GPU 611 forms the above-mentioned frame pipeline. Also, the video decoder 605, the CPU 607, the GPU 611 may be the above-mentioned non-inference unit, and the AI processor 609 may be the above-mentioned inference unit. The frame generation device may be any device which can generate frames, such as a mobile phone, a plate computer or a laptop computer.

In view of above-mentioned embodiments, the power consumption of the frame generation device may be optimized even if the frame generation device is executing a 3rd-party application.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power consumption management method, for managing power consumptions of units for performing a frame generation procedure to generate frames required by an application, comprising:
(a) deciding a first operation time of at least one non-inference unit for performing non-inference stages of the frame generation procedure according to a target performance time determined by the application and historical data relevant to the non-inference stages;
(b) computing a second operation time of an inference unit for performing an inference stage of the frame generation procedure, according to the target performance time and the first operation time; and
(c) setting configurations of the inference unit according to the second operation time;
wherein the at least one non-inference unit has a first power consumption rate higher than a second power consumption rate of the inference unit.

2. The power consumption management method of claim 1, wherein the step (a) decides the first operation time under a premise that the sum of the first operation time and the second operation time, based on the historical data, is less than or equal to the target performance time.

3. The power consumption management method of claim 1, wherein the configurations of the inference unit includes a number of operating cores of the inference unit and operating frequencies corresponding to the operating cores, and the configurations are set under a premise that the sum of the first operation time and the second operation time is less than or equal to the target performance time.

4. The power consumption management method of claim 1, wherein the step (b) reduces an operation level of the at least one non-inference unit as much as possible to decide the first operating time.

5. The power consumption management method of claim 1, wherein the non-inference unit is a video decoder, a CPU or a GPU.

6. The power consumption management method of claim 5, wherein the inference unit is an AI processor.

7. The power consumption management method of claim 1, wherein if the second operation time has a minimum threshold.

8. The power consumption management method of claim 1, wherein the target performance time is determined based on a target frame rate of the frames.

9. A power consumption management method, for managing power consumptions of units for performing a frame generation procedure to generate frames required by an application, comprising:
acquiring first power consumptions of a plurality of combinations respectively corresponding to different ones of first candidate operation times of a non-inference unit and different ones of second candidate operation times of an inference unit, wherein the first candidate operation times and the second candidate operation times are recorded in a first table; and
selecting one of the first candidate operation times as a first operation time of the non-inference unit and one of the second candidate operation times as a second operation time of the inference unit, according to the first power consumptions and the target performance time, under a premise that the sum of the first operation time and the second operation time is less than or equal to the target performance time.

10. The power consumption management method of claim 9, further comprising:
acquiring second power consumptions corresponding to operation levels of the units except the non-inference device and the inference device, wherein the second power consumptions are recorded in a second table;
selecting one of the operation levels according to the second power consumptions under a premise that the sum of the first operation time, the second operation time and operation times of the units except the non-inference device and the inference device is less than or equal to the target performance time.

11. A frame generation device, for performing a frame generation procedure to generate frames required by a multimedia application, comprising:
a non-inference unit;
an inference unit;
a performance arbitrator, configured to perform following steps:
(a) deciding a first operation time of at least one non-inference unit for performing non-inference stages of the frame generation procedure according to a target performance time determined by the application and historical data relevant to the non-inference stages;
(b) computing a second operation time of an inference unit for performing an inference stage of the frame generation procedure, according to the target performance time and the first operation time; and
(c) setting configurations of the inference unit according to the second operation time;
wherein the at least one non-inference unit has a first power consumption rate higher than a second power consumption rate of the inference unit.

12. The frame generation device of claim 11, wherein the step (a) decides the first operation time under a premise that the sum of the first operation time and the second operation time, based on the historical data, is less than or equal to the target performance time.

13. The frame generation device of claim 11, wherein configurations of the inference unit includes a number of operating cores of the inference unit and operating frequencies corresponding to the operating cores, and the configurations are set under a premise that the sum of the first operation time and the second operation time is less than or equal to the target performance time.

14. The frame generation device of claim 11, wherein the step (b) reduces an operation level of the at least one non-inference unit as much as possible to decide the first operating time.

15. The frame generation device of claim 11, wherein the non-inference unit is a video decoder, a CPU or a GPU.

16. The frame generation device of claim 15, wherein the inference unit is an AI processor.

17. The frame generation device of claim 11, wherein if the second operation time has a minimum threshold.

18. The frame generation device of claim 11, wherein the target performance time is determined based on a target frame rate of the frames.
